(19) United States
(12) Patent Application Publication
(10) Pub. No.: US 2010/0166936 A1
(43) Pub. Date: Jul. 1, 2010

(54) METHOD OF PRODUCING A CHEESE, AND CHEESE OBTAINED

(75) Inventor: Olivier Furling, Sable Sur Sarthe (FR)

Correspondence Address: YOUNG & THOMPSON, 209 Madison Street, Suite 500, Alexandria, VA, 22314, US

(73) Assignee: FROMAGERIES BEL, PARIS (FR)

(21) Appl. No.: 12/161,228

(22) PCT Filed: Jan. 12, 2007
(86) PCT No.: PCT/FR2007/000060

§ 371 Date: Oct. 16, 2008

(30) Foreign Application Priority Data
Jan. 18, 2006 (FR) 0600464

(51) Int. Cl. A23C 19/00; A23C 19/09

(52) U.S. Cl. 426/582; 426/518; 426/506

(57) ABSTRACT

Process for preparing a cheese having the organoleptic and textural characteristics of a cheese of the natural cheese type, according to which: -the starting cheese material is ground so as to obtain a finely divided starting material, -the finely divided starting material is subjected to a kneading/cooking treatment at a temperature below 80° C., with holding for between 20 s and 5 min and a rate of rotation of less than 1000 rpm, in order to obtain a homogeneous paste, -the paste is subjected to a heat treatment at a temperature of between 80° and 140° for 10 seconds to 5 minutes, -the paste is cooled and, optionally, it is shaped and packaged in a wrapping.

The present invention relates to a cheese with a long storage life, wherein at least part of the storage is unchilled, the cheese having the organoleptic and textural characteristics of a natural cheese. More particularly, the invention relates to a cheese with the characteristics of a hard cheese.

Cheeses can be produced directly by processing milk; their specific organoleptic and storage characteristics result from their manners of manufacture. Such cheeses are termed “natural cheeses”. They have a short storage life, in general less than 1 month, chilled in the range 4° C. to 6° C.

Several categories of natural cheese exist, in particular “unripened cheese” essentially obtained by acid coagulation that is ripened very briefly or not at all. Such a cheese has a short storage life, generally less than 1 month.

Soft cheeses also exist that are obtained essentially by mixed coagulation and that are preferably are ripened for a period of one to four weeks; they may have a surface flora.

The organoleptic characteristics of such soft cheeses are determined by the internal and external flora. Such products have a limited storage life, requiring storage temperatures in the range 4° C. to 6° C. because of the ever-present possibility that the flora will proliferate.

Finally, hard cheeses exist that are obtained by coagulation with a coagulating agent (for example rennet) followed by a step of pressing the curd and ripening; they may have superficial flora. Such cheeses have a longer storage life than those in the preceding two categories.

All of those categories of cheese must be stored under refrigeration, preferably at a temperature in the range 4° C. to 8° C., which limits their consumption outdoors and limits opportunities for marketing in geographical areas that do not have suitable distribution networks.

Processed cheeses are also known that are obtained by heat treatment, to temperatures that may be as high as 140° C., of natural type cheese and/or curd, possibly in the presence of emulsifying salts and other dairy produce such as butter, whole or skimmed milk powder, lactoserum powder, protein concentrates, etc, or even fat and/or vegetable proteins.

Such processed cheeses have the characteristic of having a long storage life that may be as long as one year, and of being able to be stored and marketed in networks that do not have cold storage units.

However, because of the manner of their manufacture, said processed cheeses no longer have their original textural and taste characteristics. Further, said cheeses are often derived from a mixture of various starting materials, that also contributes to the production of products that taste different from the natural cheeses.

In particular, an analysis of the degree of peptization, resulting from a change in the structure of proteins during the manufacturing method, measured by the amount of sedimentable nitrogen linked to the liberation of soluble proteins during the pasteurization treatment, indicates a value in the range 40 to 50 for processed cheeses treated at a temperature of more than 100° C., while the degree of peptization is of the order of 0 for natural cheeses.

A method has been proposed for producing cheese products in a variety of formats, comprising a step which consists in heat treating cheeses to improve storage; United States patent U.S. Pat. No. 1,522,383 describes a method that produces a cheese emulsion at low temperature (35° C. to 40° C.) with destruction of the original texture of the product. The aim of the destructuring is to be able to create a stable emulsion that does not destabilize during subsequent processing, pasteurization, or sterilization treatments, i.e. without fat exudation. To create a stable emulsion, the author proposes using emulsifying agents. For that reason, the product obtained by that treatment resembles a processed cheese in texture rather than a natural hard type cheese.

U.S. Pat. No. 1,522,384 relates to the application of a pasteurization or sterilization treatment (up to 100° C.) to products obtained by emulsification using U.S. Pat. No. 1,522,383.

As in U.S. Pat. No. 1,522,383, the original texture of the product is destroyed and the product obtained resembles a processed cheese and not a natural cheese. Further, subsequent pasteurization or sterilization treatments applied to the emulsion obtained in step 1 are carried out below 100° C.

Furthermore, the equipment described in those patents causes substantial shear along with heterogeneities in heating due to friction of the product against the walls. Further, no indications are given regarding the storage lives of the products obtained, nor regarding the temperatures at which such products have to be stored.

In contrast to the teaching of those patents, which describe products where the original texture of the cheese employed is destroyed, methods have been proposed to produce products where the texture is close to that of natural cheeses, in particular that of hard cheeses. In this respect, French patent application FR-98/06319 can be mentioned; the products obtained therefrom have the texture and taste characteristics of the products from which they are derived. However, they need to be placed in cold storage (between 4° C. and 8° C., preferably between 4° C. and 6° C.) since, because they have been treated at a temperature of less than 70° C., they could contain heat resistant flora that constitute a factor in the degradation of products and can give rise to health risks.

Further, such products have residual enzymatic activities because of their moderate heat treatment, which entails carrying out a ripening process with changes in texture and taste that may not be desirable.

In any event, such products have a storage life of less than four months, and necessarily under cold storage.

Other analogous methods have been described. Such methods all use treatment temperatures that also require cold storage of the product. Further, such methods as described in European patent applications EP-A-0 535 728 and EP-A-0 948 897, for example, require blends of products, which results in final products having organoleptic properties that differ from those of the original products.

All of the products described in those patents suffer from the major disadvantage of requiring cold storage temperatures 4° C. to 6° C.) required by the heat treatments, which makes it impossible to market the products in geographical areas with distribution networks that do not have means for keeping the products at low temperatures, i.e. for consumption in the form of snacks without cold storage and, with the exception of FR-94/8897, of having textural characteristics that are very different from those of a natural cheese, more specifically those of hard cheeses.

Now, in a novel and unexpected manner, the Applicant has demonstrated that it is possible to obtain cheeses with a storage life of more than three months, that might be greater than 6 months, and that could even attain one year, including prolonged periods of unchilled storage and with the textural characteristics of natural hard type cheeses.

Thus, the aim of the present invention is to propose cheeses with organoleptic and textural characteristics close to those of natural cheeses, of the hard type and with a prolonged storage life that is partially unchilled.

To this end, the invention provides a method of preparing a cheese in which:

the starting cheese material is milled to obtain a finely divided starting material;

a kneading/cooking treatment is carried out on the finely divided starting material at a temperature of less than 80° C. with a holding period in the range 20 s [seconds] to 5 min [minutes], preferably less than 3 min, and at a rotation rate of less than 1000 rpm [revolutions per minute] to obtain a homogeneous cheese paste;

the cheese paste is heat treated at a temperature in the range 80° C. to 140° C., preferably more than 105° C., and more preferably more than 110° C., for 10 seconds to 5 minutes;

the cheese paste is cooled, optionally shaped and then packaged.

Thus, a cheese is produced with organoleptic and textural characteristics close to those of natural cheeses, in particular of the “hard” type, with a prolonged and partially unchilled storage life.

The term “prolonged storage life” means periods of up to one year and “partially unchilled storage” means a period of up to 3 months at ambient temperature. As an example, products in accordance with the invention can have a storage life of 6 months with a storage period at ambient temperature of up to 2 months. In any event, the products of the invention have a storage life of more than 3 months including more than 1 month unchilled.

Preferably, the heat treatment is carried out in a reactor for treatment by resistance heating with no mechanical treatment, i.e. with no simultaneous shearing operation.

The reactor for treatment by resistance heating may operate in a continuous manner.

The reactor for treatment by resistance heating may also operate in a discontinuous manner.

The kneading/cooking treatment is carried out at a temperature in the range 30° C. to 80° C., preferably in the range 40° C. to 70° C.

Before or after the kneading/cooking treatment, water may be added to the cheese.

The starting cheese material may include a cheese of the hard type with more than 30% dry matter, a fat content in dry matter (FDM) in the range 0 to 70%, and having the organoleptic and textural characteristics of a hard cheese, for example or a ripened cheese.

The starting material may include additives such as protein concentrates, milk or lactoserum powders, vegetable starting materials and flavoring agents, the additives being in proportions such that they do not denature the intrinsic qualities of the original cheese.

The invention also provides a cheese having the organoleptic and textural characteristics of a natural cheese type cheese, with a storage life of more than 3 months unchilled.

The cheese has the organoleptic and textural characteristics of a natural hard type cheese with a dry matter of more than 30%, an FDM in the range 0 to 70% and with the organoleptic and textural characteristics of a ripened cheese.

The invention is described below in more detail and in a non limiting manner with reference to the accompanying figures, in which:

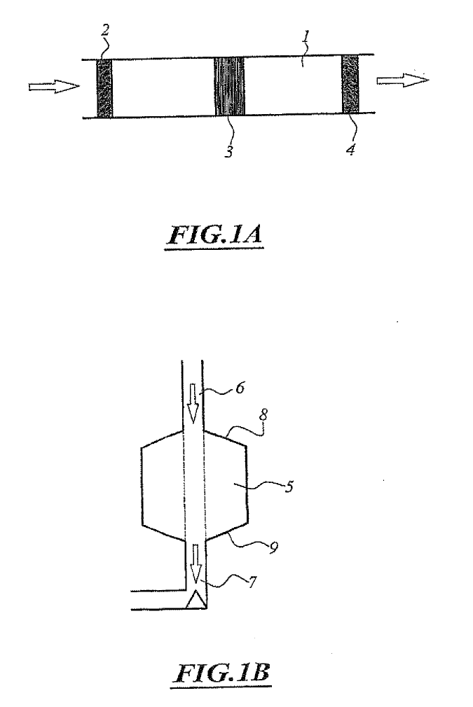

FIGS. 1A and 1B diagrammatically show the chambers for heating cheese by resistance heating, in respective continuous and discontinuous modes;

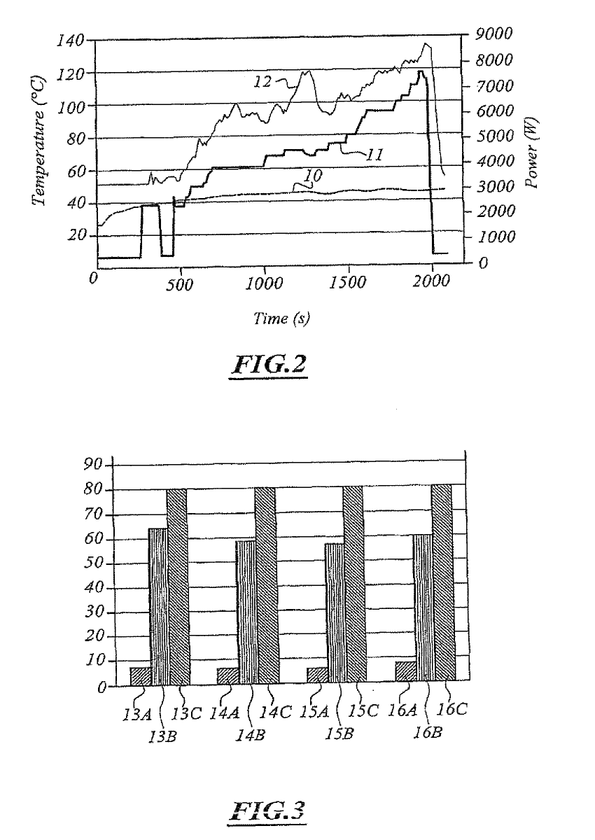

FIG. 2 shows the change in the inlet temperature and outlet temperature of cheeses passing through a continuous resistance heater unit in a first example;

FIG. 3 shows the characterization of cheese products obtained by resistance heat treatment corresponding to a first example;

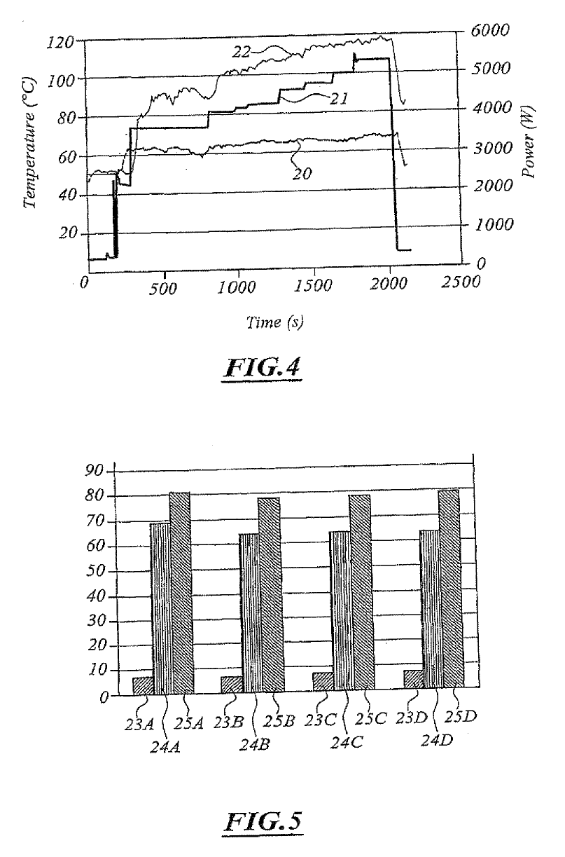

FIG. 4 shows the change in the inlet temperature and outlet temperature of cheeses in a unit for heat treatment by resistance heating in a second example;

FIG. 5 compares the characteristics of cheeses treated by the resistance heat treatment method in a second example.

The starting material is a hard cheese obtained using traditional techniques from milk using steps for standardizing the milk as regards fat and protein, optional pasteurization of the standardized milk, coagulation using coagulating agents, draining, pressing, optional brining and ripening. The dairy fat may be completely or partially substituted with vegetable fat.

However, products obtained by reconstituting dairy and/or vegetable materials and concentrated dairy proteins are within the scope of the invention.

The starting cheese material is, for example, a hard cheese with dry matter of more than 30%, preferably more than 40%, a fat content expressed relative to the dry matter in the range 0 to 70% and with the textural characteristics of a traditional hard cheese expressed by the rheological parameters of firmness, elasticity, and cohesiveness. As an example, a Gouda type hard cheese has a firmness of 5.7 N [Newtons], an elasticity of 77% and a cohesiveness of 63%; these values are mean values and were measured by the texture profile analysis (TPA) test using the protocol described in the examples. Examples of cheeses used as starting material and that may be mentioned are cheeses such as Cheddar, Gouda, Edam, Parmesan, Cantal, Tommes, or Manchego.

The starting material also includes ingredients and/or additives such as protein concentrates, milk and/or lactoserum powders, or flavoring agents, these products being incorporated in proportions that do not denature the texture of the original cheese.

This starting material is initially milled to obtain a starting material in the finely divided form with the consistency, for example, of grains of semolina, to which additional elements may be added, for example elements of dairy origin such as milk powder or lactoserum powder, optional protein concentrates, starting materials of vegetable origin such as fats or proteins, as well as flavoring ingredients or other elements as mentioned above. This finely divided starting cheese material initially undergoes a kneading/cooking treatment at a temperature of less than 80° C. and preferably less than 70° C., and also preferably greater than 30° C., more preferably greater than 40° C., for a time that is preferably in the range 20 s to 5 min, more preferably in the range 30 s to 3 min, and still more preferably of the order of 40 s, in a kneading/cooking unit such as a “cutter” type unit with a rotor turning at a rotation rate of less than 1000 rpm, to obtain a homogeneous, relatively viscous cheese paste with little or no fat exudation.

During this kneading/cooking treatment, and preferably before said kneading or after said kneading, water may be introduced into the paste or into the starting material in a quantity that may be up to 20% of the weight of the starting cheese material.

Such a method, which is known to the skilled person, may be carried out continuously or discontinuously.

When carried out discontinuously, the product obtained may be left to rest for a time that is sufficient to ensure good homogeneity of the paste. This time may, for example, be of the order of one hour. The paste is then introduced into a device for heat treatment by resistance heating, which is known per se, to undergo heat treatment at a temperature in the range 80° C. to 140° C., preferably more than 105° C., more preferably more than 110° C., for a time in the range 10 s to 5 min, with no simultaneous shearing operation, or optionally with a very gentle shearing action essentially resulting from circulation of the cheese paste in the unit.

This treatment may also include holding, which is applied to the product in order to sterilize the product. In general, the lower the treatment temperature, the longer the holding time in order to achieve satisfactory sterilization.

Heat treatment by resistance heating is known per se and its use for the treatment of cheeses has already been described. The method described in U.S. Pat. No. 1,774,610 may be mentioned, which describes a method of pasteurizing (60° C. to 65° C.) cheeses by passage through a resistance heating reactor; however, the initial structure of those processed products has been destroyed, as in the method described in U.S. Pat. No. 1,522,383, to attempt to obtain better results. If the resistance heating were to carry out heat treatment (pasteurization) of these starting materials, the final product would lose the texture of the original product and its texture would in no way resemble that of a natural hard type cheese. Further, the temperatures applied would not disinfect the product sufficiently to allow long storage lives if storage were at ambient temperature.

Units for performing heat treatment by resistance heating are known per se, and FIG. 1A shows a continuous unit that consists of a tubular chamber 1 in which the cheese moves in the direction of the arrow.

The tubular chamber 1 comprises three annular electrodes 2, 3, 4. Two annular electrodes 2, 4 are connected to neutral and one annular electrode 3 is connected to the live phase. When the cheese paste moves in this annular chamber and the electrodes are connected to a source of electricity, and since the cheese paste is conductive, an electric current moves through the cheese paste between the various electrodes. This circulation of electric current causes Joule effect heating of the cheese paste that has the advantage of occurring homogeneously (bulk heating).

In a second implementation of resistance heating of the cheese as shown in FIG. 1B, a vertical chamber 5 comprises an inlet for the cheese paste via the upper portion 6 and removal via the lower portion 7.

In its upper portion, the heating chamber 5 comprises a first electrode constituting a nozzle 8 and its lower portion has a second electrode forming a receptacle 9. When the cheese paste arrives in this chamber, which has a diameter greater than that of the supply and removal lines for the cheese paste, an electric current passes through the cheese paste and heats it homogeneously.

In this method, the cheese paste is not in contact with the walls throughout the heating period, allowing homogeneous heating.

These units may also optionally include dynamic mixer type devices that can advantageously homogenize the product as regards temperature in a section of the unit.

At the outlet from the resistance heater unit, the cheese paste is cooled either using a fast vacuum chilling system or a flash system, which is known per se, or in a conventional unit comprising tube heat exchangers, for example.

After cooling, the cheese paste may optionally be shaped into portions, balls, or slices. Finally, the cheese or the cheese portions are packed conventionally into any known packaging such as aluminum, plastic shells, wax coating, into boxes, or into sachets.

The method of the invention, which includes heat treatment at relatively high temperatures without simultaneous mechanical treatment, has the advantage of being capable of producing cheeses with textural and organoleptic characteristics that are close to those of the starting materials employed, and also has the advantage of not having residual flora that could render unchilled storage or long term storage difficult.

In particular, the method of the invention can produce cheeses with the organoleptic and textural characteristics of a natural cheese while being capable of being stored for up to one year under cold storage or six months unchilled, which is much longer than the storage times for a traditional natural cheese.

The finished product of the invention has the textural characteristics of a traditional hard cheese expressed in terms of firmness, cohesiveness, and elasticity, with dry matter of more than 30%, preferably more than 40%, and with a fat content, expressed relative to the dry matter, in the range 0 to 70% and that advantageously has the organoleptic and textural characteristics of a ripened cheese and a storage life that may be up to 1 year with an unchilled period that may be as long as 3 months. In fact, the heat treatment carried out on the product destroys technological and pathogenic flora. This effect has been demonstrated on deliberately inoculated flora in the context of a challenge test wherein 70° C. treatments indicated the following reductions:

a reduction of 4 powers of ten for a strain of Listeria innocua;

a reduction of 3 powers of ten for a strain of Enterococcus faecium;

a reduction of 4 powers of ten for a coliform type species (Hafnia alvei);

a reduction of 4 powers of ten for a strain of Staphylococcus aureus.

Complementary tests on a 85° C. treatment for 3 min eliminated the contaminating strains and observations showed that the heat treatments applied reduced the technological flora.

A 70° C. treatment resulted in the following reductions:

a reduction of mesophilic and thermophilic lactobacillae of 3 powers of ten;

a reduction of 4 powers of ten for Streptococcus Thermophilus;

a reduction of 3 powers of ten for lactococcus.

Further, molds and micro-organism yeasts that are highly thermostable at 70° C. were completely eliminated.

These elements have a positive effect on the storage life of the products, since eliminating flora prevents degradation caused by that flora.

Such a product has the advantage of being able to be consumed in the open or of being marketed in geographical areas where the distribution networks do not have cold storage means.

Rheological tests or TPA tests, which are indicators of protein denaturing, have been carried out to compare natural control cheeses and cheeses obtained by the method carried out at 95° C., 120° C. and 135° C. Those tests show that the characteristics of the cheeses treated by the method described above are very close to the characteristics of the original products.

The invention is illustrated below with the aid of two examples in which a natural cheese was initially kneaded and cooked in a cutter type cooker-mixer and stored in a starter vat then, using a volumetric pump, injected into a resistance heating stage of a heater unit to heat it continuously to a temperature of more than 80° C. and less than 140° C., then transferred into a flash bottom draw-off tank provided with an upstream counter pressure valve. Finally, the substance obtained was transferred into a vat to take a sample.

In a first example, the starting cheese material was Gouda. This starting cheese material was initially reduced into semolina-like grains which were introduced into a cutter type mixer/cooker in which it was cooked at a temperature or 65° C. and mixed with 10% of UF dairy protein concentrate obtained by passing milk over an ultrafiltration membrane. The paste obtained was then treated in a resistance heater unit at a flow rate of 200 kg/h [kilograms/hour] and the heating power was controlled to produce the desired outlet temperatures.

FIG. 2 shows the change as a function of time in the inlet temperature of the cheese in the resistance heater unit namely curve 10, the change in the power injected into the resistance heater unit, namely curve 11, and the outlet temperature for the cheese at the outlet from the unit, namely curve 12.

It can be seen from these curves that the treatment temperatures changed and in particular exhibited constant temperature stages at about 95° C., at about 119° C., and at about 135° C.

For each of these constant temperature stages, samples were taken that underwent a TPA rheological test. This test was also carried out on the original natural cheese, in particular at the outlet from the mixer/cooker.

In particular, the force 1, cohesiveness and elasticity were measured. The results are shown in FIG. 3 where the vertical bars 13A, 14A, 15A, 16A represent the force 1 respectively for the sample from the mixer/cooker, the sample removed after the resistance heat treatment at 95° C., after the resistance heat treatment at 119° C., and finally after resistance heating at 135° C.

Vertical bars 13B, 14B, 15B, 16B represent the cohesiveness, measured under the same conditions as before.

Finally, bars 13C, 14C, 15C, 16C represent the elasticity also measured under the same four conditions as before.

The graph shows that both for the force 1, for cohesiveness and for elasticity, the characteristics of the paste obtained after the resistance heat treatment between 80° C. and 140° C. are substantially equal to the characteristics of the control cheese paste at the outlet from the cooker/mixer.

It appears from this comparison that the cheeses obtained by the process have rheological, organoleptic and textural characteristics comparable to those of the original cheese.

Jury sensorial analysis taste tests noted no occurrences of false flavors or loss of texture compared with the control.

Further, it was shown that the cheeses obtained could be stored for six months unchilled and for up to one year at a temperature in the range 4° C. to 8° C.

In a second example, the base starting material was Emmenthal, and the treatment was carried out under the same conditions as for the preceding example.

The change in temperatures and the power supplied with time is shown in FIG. 4 in which curve 21 represents the temperature at the inlet to the resistance heater unit, curve 22 represents the power supplied to the resistance heater unit, and curve 23 represents the temperature of the cheese obtained at the outlet from the heat treatment unit.

FIG. 5 shows, as above, the results of the TPA test in which bars 23A, 238, 23C, and 23D represent the force 1 determined on a sample removed from the outlet from the mixer/cooker, and on samples from the outlet from the resistance heater unit after heat treatment at temperatures of 95° C., 107° C., and 117° C. respectively.

Bars 24A, 24B, 24C, 24D represent the cohesiveness, measured under the same four conditions.

Finally, the bars 25A, 253, 25C, 25D represent the elasticity, also measured under the four conditions defined above.

These graphs, which correspond to the results obtained from samples corresponding to cylinders 12 mm [millimeter] in diameter and 12 mm high, on which two successive compressions were carried out, show that resistance heat treatment causes only minimal differences in the three characteristics of force 1, cohesiveness and elasticity of the cheese.

Comparative taste tests were also carried out on the control product and the treated products. These taste tests did not show significant differences between the original cheese and the cheese after heat treatment.

The method of the invention thus produces a cheese that has the advantage of having the organoleptic and textural characteristics of natural cheeses while having storage times comparable to those of processed cheeses.

1-12. (canceled)

13. A method of preparing a cheese with the organoleptic and textural characteristics of a natural type cheese, in which:
the starting cheese material is milled to obtain a finely divided starting material;
a kneading/cooking treatment is carried out on the finely divided starting material at a temperature of less than 80° C., with a holding period in the range 20 s to 5 min and at a rotation rate of less than 1000 rpm, to obtain a homogeneous cheese paste;
the cheese paste is heat treated at a temperature in the range 80° C. to 140° C. for 10 seconds to 5 minutes;
the cheese paste is cooled, optionally shaped and then packaged.

14. A method according to claim 13, wherein the heat treatment is carried out at a temperature of more than 105° C.

15. A method according to claim 13, wherein the heat treatment is carried out in a reactor for treatment by resistance heating without mechanical treatment.

16. A method according to claim 15, wherein the reactor for treatment by resistance heating operates in a continuous manner.

17. A method according to claim 15, wherein the reactor for treatment by resistance heating operates in a discontinuous manner.

18. A method according to claim 13, wherein the kneading/cooking is carried out at a temperature in the range 30° C. to 70° C.

19. A method according to claim 13, wherein before or after the kneading/cooking treatment, water is added to the cheese paste in a quantity of less than 20% of the weight of the paste.

20. A method according to claim 13, wherein the starting cheese material is of the “natural cheese” type.

21. A method according to claim 20, wherein the starting cheese material comprises a hard type cheese containing more than 30% dry matter, a fat content in dry matter in the range 0 to 70%, and has the organoleptic and textural characteristics of a traditional hard cheese.

22. A method according to claim 20, wherein the starting material further includes additives such as protein concentrates, milk or lactoserum powders, vegetable starting materials, and flavoring agents, the additives being in proportions such that they do not denature the intrinsic qualities of the starting cheese.

23. A cheese having the organoleptic and textural characteristics of a natural cheese type cheese, obtainable by the method of claim 13, the cheese having a storage life of more than 3 months unchilled.

24. A cheese according to claim 23, the cheese having the organoleptic and textural characteristics of a natural hard cheese type cheese with dry matter of more than 30%, a fat content in dry matter in the range 0 to 70%, and has the organoleptic and textural characteristics of a traditional hard cheese.
